(19) United States
(12) Patent Application Publication
(10) Pub. No.: US 2021/0134148 A1
(43) Pub. Date: May 6, 2021

(54) ELECTRONIC VEHICLE HEIGHT CLEARANCE SYSTEM

(71) Applicant: Umm Al-Qura University, Makkah (SA)

(72) Inventor: Khalid Aboalshamat, Makkah (SA)

(73) Assignee: Umm Al-Qura University, MAKKAH (SA)

(21) Appl. No.: 16/675,175

(22) Filed: Nov. 5, 2019

Related U.S. Application Data
(63) Continuation-in-part of application No. 16/675,152, filed on Nov. 5, 2019.

(51) Int. Cl. G08G 1/01; G08G 1/04; G08G 1/16

(52) U.S. Cl. CPC G08G 1/0116; E05Y 2800/116; G08G 1/165; G08G 1/04

(57) ABSTRACT

The present disclosure relates to an electronic vehicle height clearance system, comprising: an infrared emission bar; a photo-sensor bar; an entrance gate and an electronic sign, wherein the system help in managing a vehicle with height above or below a permissible level for an area where the system is installed. The system generates an infrared line, wherein if the vehicle pass through the entrance without crossing the infrared line, it indicates that the vehicle in within the permissible height, however if the vehicle crosses the infrared lines it indicates that the vehicle is above the permissible height and thus should not or cannot pass the entrance gate.

### CROSS REFERENCE TO RELATED APPLICATION

This application is a continuation in part of and claims priority to patent application Ser. No. 16/675,152 filed on Nov. 5, 2019. The entire application is hereby incorporated by reference.

### FIELD OF TECHNOLOGY

This disclosure relates generally to an electronic vehicle height clearance system and more particularly to allow a garage facility or parking lot to manage vehicles with above the permissible height to enter into the facility.

### BACKGROUND

Garages or parking lots which have a vehicle height restrictions, usually have a way of dealing with such vehicles by posting a sign at a visible area indicating the maximum height or a horizontal bar hanged from the ceiling to guide the vehicle when they enter into the garage or the parking lot. However, a driver may sometimes is not aware of the height of his vehicle and decides to go forward even after the height indicators and ends up damaging the vehicle and/or the property. There is a need for a better management system for vehicles with above the permitted height in garage facilities or parking lot.

### SUMMARY

The present disclosure relates to an electronic vehicle height clearance system. More specifically, the disclosure relates to an electronic vehicle height clearance system with a sensor, such that the sensor helps in indicating a driver of a vehicle that their vehicle is above the permitted height, as required to enter a garage facility or a parking lot.

In one embodiment, the system as disclosed comprise of a bar; an entrance gate; and an electronic sign. In another embodiment, the system comprises of a photo-sensor bar and an infrared emission bar. In yet another embodiment, the infrared emission bar may be installed at a required distance from a garage or a parking lot entrance gate. The distance will depend on how early a signal should reach the driver to let the driver know about vehicle height such that driver can stop the vehicle and also there should be enough space for the vehicle to turn around. Further, the photo-sensor bar may be present at a distance of approximately 2.5 meters from the infrared emission bar, such that the photo-sensor bar and the infrared emission bar are present on opposite side of the garage or a parking lot entrance gate. However, the distance between the photo-sensor bar and the infrared emission bar may also depend on the distance of the entrance way to the garage or parking lot or other such area where the system may be installed.

In one embodiment, the infrared emission bar further comprise of an infrared emission compartment whereas in another embodiment, the photo-sensor bar comprise of a photo-sensor compartment. The infrared emission compartment and the photo-sensor compartment are present at such a height which is equivalent to the permissible height for the garage or parking lot or other such area where the system is installed.

In one embodiment, the infrared emission compartment as attached to the infrared emission bar is a hollow cylindrical metallic body. In another embodiment, the infrared emission compartment may be of other shape such as a rectangle, square as referenced to the shape of the infrared emission bar. The cylindrical shape is open from one side and comprise of more than one wing, which forms an opening. The infrared emission compartment can further be adjusted, moved up or down and fixed onto the infrared emission bar. There is a hole present onto the wings of the infrared emission compartment, wherein a screw can pass through the hole and with the screw nut can help fix the infrared emission compartment at a desirable height onto the infrared emission bar. The infrared emission compartment further comprise of an infrared piece that emits an infrared signal towards the photo-sensor bar, wherein the photo-sensor bar is present on the same line of axis as of the infrared emission bar.

In one embodiment, the photo-sensor compartment as attached to the photo-sensor bar is a hollow cylindrical metallic body. In another embodiment, the photo-sensor compartment may be of other shape such as a rectangle, square as referenced to the shape of the photo-sensor bar. The cylindrical shape is open from one side and comprise of more than one wing, which forms an opening. The photo-sensor compartment can further be adjusted, moved up or down and fixed onto the photo-sensor bar. There is a hole present onto the wings of the photo-sensor compartment, wherein a screw can pass through the hole and with the screw nut can help fix the photo-sensor compartment at a desirable height onto the photo-sensor bar. The photo-sensor compartment further comprise of a photo-sensor piece. The photo-sensor piece and the infrared piece are position in such a way that they face each other and forms an invisible line, invisible to naked eye, when the system is in ON position.

In one embodiment, the system as disclosed further comprise of an entrance gate. The entrance gate is either in ON or OFF position, where ON position indicates that the gate is in the entrance way and is blocking the entrance of the vehicle whereas OFF position indicates that the gate is away from the entrance way, allowing a vehicle to pass through the entrance way to the garage or parking lot or other such area. In another embodiment, an electronic sign is present on the entrance gate, such that the electronic sign display a warning message or other such message for driver of the vehicle.

In one embodiment, the photo-sensor compartment is present at a distance of approximately 0.5 meter from the entrance gate. In another embodiment, the infrared emission compartment is present at a distance of approximately 2.5 meters from the photo-sensor compartment. The infrared emission bar and the photo-sensor bar are installed on either side of the entrance way to the garage or the parking lot such that the infrared piece and the photo-sensor piece face each other. All the compartments and the system is linked to an electronic source.

In one embodiment, an infrared signal being emitted from the infrared piece falls onto the photo-sensor piece present on the photo-sensor compartment and forms an infrared line. In another embodiment, as the system is switch to ON position an infrared line is formed which are invisible to a naked eye.

Thus, in one embodiment, an electronic vehicle height clearance system is disclosed comprising: an infrared emission bar; a photo-sensor bar; an entrance gate and an electronic sign, wherein the system help in managing a vehicle with height above or below a permissible level for an area where the system is installed. In another embodiment, the electronic vehicle height clearance system further comprises: an infrared emission compartment fixed onto the infrared emission bar and a photo-sensor compartment fixed onto the photo-sensor bar. In yet another embodiment, the system as disclosed comprises: an infrared piece present on the infrared emission compartment and a photo-sensor piece present on the photo-sensor compartment, wherein infrared piece emits an infrared signal such that the infrared signal falls onto the photo-sensor piece to form a line invisible to a naked eye.

In one embodiment, a functioning of an electronic vehicle height clearance system is disclosed. The functioning as disclosed, comprising: switching ON the system, such that an infrared signal is emitted from an infrared emission compartment; forming of an infrared line, wherein the line is formed when the infrared signal from the infrared emission compartment falls onto a photo-sensor compartment present on a photo-sensor bar; moving of an entrance gate into an entrance way to the garage or parking lot, such that the entrance gate blocks the entrance way for any vehicle; passing of a vehicle through the system to enter into the garage or parking lot; and moving of the vehicle into the garage or parking lot through an entrance gate, such that if the vehicle is within the permissible height it will not cross the infrared line and will lead to opening of the entrance gate. In another embodiment, the functioning as disclosed further comprises: blocking of the entrance way, wherein the entrance way will be blocked by entrance gate being in close position; and displaying a message onto an electronic sign, wherein the sign indicates a message to the driver that the vehicle is above the permissible height.

Thus, in most embodiments, as the vehicle pass through the entrance of the garage or the parking lot entrance gate, the vehicle will pass in between the infrared compartment and the photo-sensor compartment, wherein if the vehicle cross an infrared line emitted from the infrared compartment, entrance gate will not open to allow the vehicle to pass through.

The system as disclosed depend on a photo-sensor and an infrared to detect the height of the vehicle. As soon as the vehicle crosses the line, a signal will be passed to the entrance gate to not open along with a message display onto the electronic sign.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 shows embodiments of disclosed electronic vehicle height clearance system.

FIG. 2 shows a top view of the disclosed system.

FIG. 3 shows structural details of an infrared emission compartment.

FIG. 4 shows structural details of a photo-sensor compartment.

FIGS. 5A and 5B shows functioning of the disclosed system.

FIG. 6 shows a step-by-step functioning of the disclosed system.

Other features of the present embodiments will be apparent from the accompanying drawings and from the detailed description that follows.

### DETAILED DESCRIPTION

When a garage or parking lot is constructed for a residential or commercial building, they usually have a gate to give a permission to the eligible vehicle to enter. For example, when a driver enter the right numbers on the parking keypad or when the driver click on the garage remote, it gives them a permission to enter into the garage or parking lot. All the commercial or residential garage or parking lot have a height limitation whereby a vehicle with a particular height can be parked and does not allow vehicles with a height above those permissible limits. It is important to indicate a garage height limit because some large vehicle of a resident or a guest may have more height than the required and the driver of that vehicle is not aware of their vehicles' height. Further, as entering into the garage or parking lot, drivers are usually in hurry, they click on the remote or keypad and decided to enter without noticing the height sign, damaging their vehicles' ceiling and the garage/parking lot ceiling as well.

The usual way to deal with the vehicle height when entering the garage or parking lot depend mainly on a sign, or a horizontal bar, hanged from the ceiling to guide the vehicle as to the permissible height within that area. However, as mentioned the driver might not be aware of the actual height of his vehicle and decided to go forward and that lead to damages requiring repairs and thus cost.

The presented invention deals with the problem and provides a electronic vehicle height clearance system that can be installed and connected to a regular garage entrance door or a parking lot entrance door which do have height restrictions.

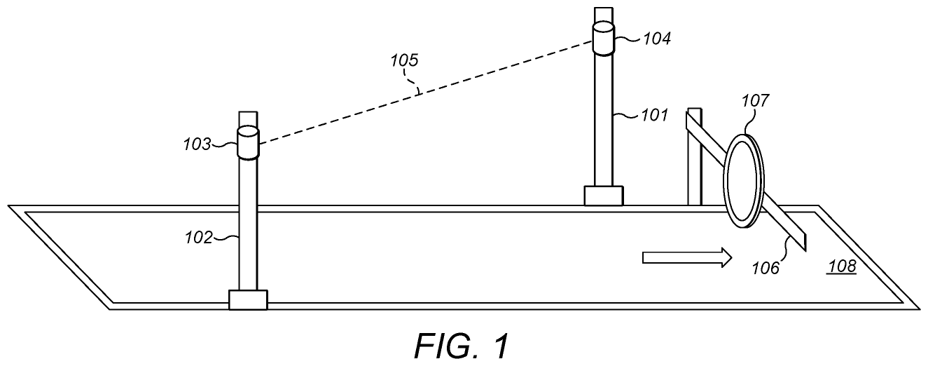

FIG. 1 shows features of the disclosed electronic vehicle height clearance system. As shown, the system comprises: a photo-sensor bar 101, an infrared emission bar 102, a photo-sensor compartment 104, an infrared emission compartment 103, an entrance gate 106 and an electronic sign 107. The infrared emission bar and the photo-sensor bar are positioned on each side of the entrance 108 to the garage or parking lot such that they face each other. The infrared emission compartment and the photo-sensor compartment are positioned such that it indicated the maximum permissible height for that place.

The infrared emission compartment emits an infrared signal such that an infrared signal is emitted from the infrared compartment 103 forming an infrared line 105. The system further comprises of an entrance gate 106. The system further comprises of an electronic sign 107 present on top of the garage or parking lot entrance gate 106. The electronic sign may be present on a desired location such as the left side or the right side of the garage or parking lot entrance gate. The entrance gate is either in ON or OFF position, where ON position indicates that the gate is in the entrance way and is blocking the entrance of the vehicle, whereas OFF position indicates that the gate is away from the entrance way, allowing a vehicle to pass through the entrance way to the garage or parking lot or other such area. Further, an electronic sign 107 is present on the entrance gate, such that the electronic sign display a warning message or other such message for driver of the vehicle.

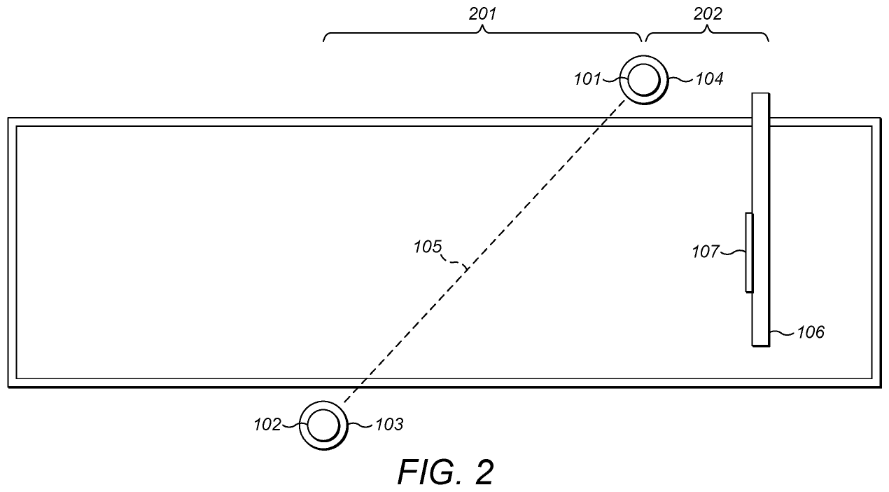

FIG. 2 shows a top view of the disclosed system showing distance between the infrared emission bar 102 and the photo-sensor bar 101 is approximately 2.5 meter 201. However, distance can be more or less depending on the number of entrances to be covered e.g if there are more than one entrance gate to the garage or parking lot, infrared and photo-sensor bar can each be fixed onto one side of the garage/parking lot covering both the entrance. Also, distance may depend on the size of the vehicles such as vehicle is a car, truck, RV or others. Further, FIG. 2 also shows that the distance between the photo-sensor bar 101 and the entrance gate 106 is approximately 0.5 meter 202. However, the distance can vary depending on the requirement of the user and the manufacturer. Also, distance between the infrared bar and the alarming bar or distance between the photo-sensor bar and the alarming bar can vary depending on all the factors as stated above and also on the owner's or manufacturer's choice.

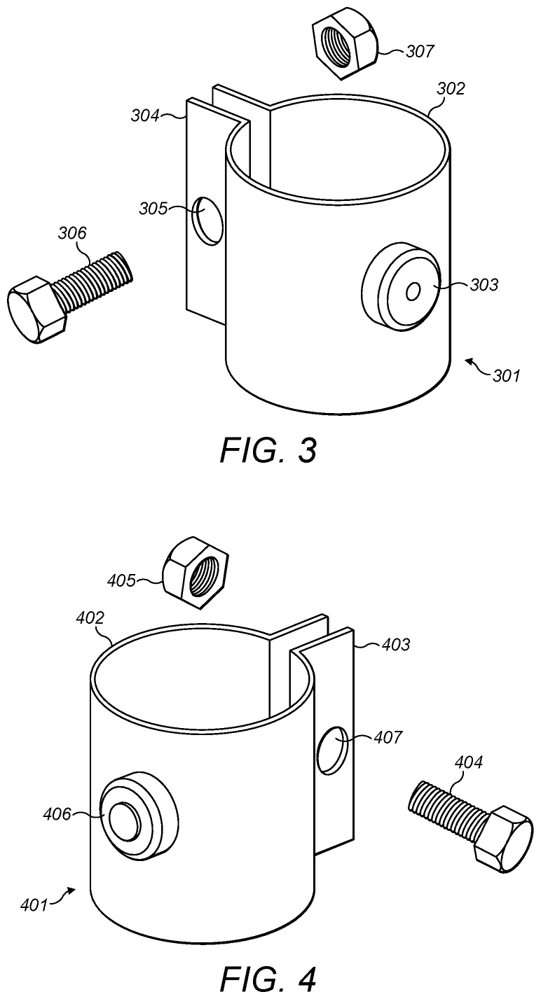

FIG. 3 shows structural details of an infrared emission compartment 301. The position of the infrared emission compartment is fixed such that it indicated the highest position for the vehicle or the permissible height. The infrared emission compartment comprises a cylindrical body 302. The cylindrical shape is open from one side and comprise of more than one wing 304, which forms an opening. There is a hole 305 present onto the wings of the infrared emission compartment, wherein a screw 306 can pass through the hole and with the screw nut 307 can help fix the infrared emission compartment at a desirable height onto the infrared emission bar. The infrared emission compartment further comprise of an infrared piece 303 that emits an infrared signal towards the photo-sensor bar 101, wherein the photo-sensor bar is present on the same line of axis as of the infrared emission bar 102. The infrared emission compartment may be of other shape such as a rectangle, square as referenced to the shape of the infrared emission bar. The infrared emission compartment can further be adjusted, moved up or down and fixed onto the infrared emission bar.

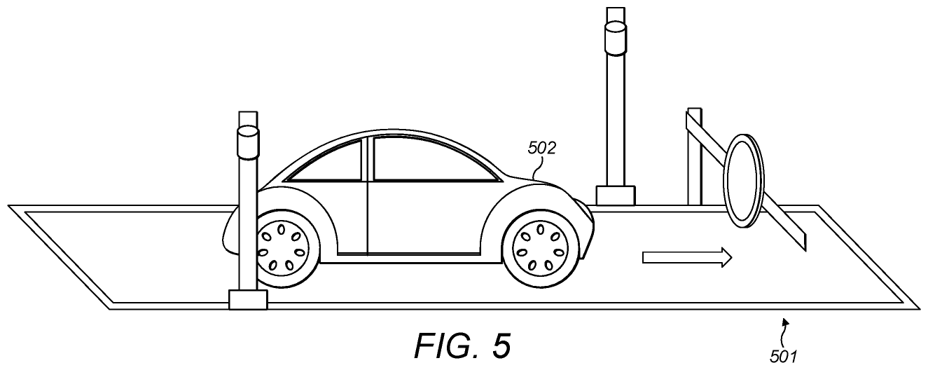

FIG. 4 shows structural details of an photo-sensor compartment 401. The photo-sensor compartment as attached to the photo-sensor bar 101 is a hollow cylindrical metallic body 402. The cylindrical shape is open from one side and comprise of more than one wing 403, which forms an opening. There is a hole 407 present onto the wings of the photo-sensor compartment, wherein a screw 404 can pass through the hole 407 and with the screw nut 405 can help fix the photo-sensor compartment at a desirable height onto the photo-sensor bar. The photo-sensor compartment further comprise of a photo-sensor piece 406. The photo-sensor piece and the infrared piece are position in such a way that they face each other and forms an invisible line, invisible to naked eye, when the system is in ON position. The photo-sensor compartment may be of other shape such as a rectangle, square as referenced to the shape of the photo-sensor bar. The photo-sensor compartment can further be adjusted, moved up or down and fixed onto the photo-sensor bar. The position of the photo-sensor compartment is fixed such that it indicated the highest position for the vehicle or the permissible height.

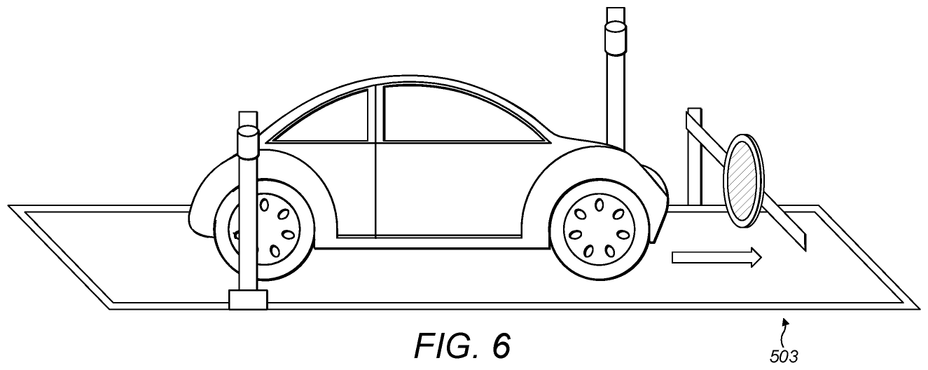

FIG. 5A shows a use of the disclosed system 501 as a vehicle 502 passes through the system. As shown, the system is showing to emit the infrared line 105 from the infrared compartment. As the vehicle passes through the entrance way 108 and thus through the system, it may cross the infrared line. If the vehicle does not crosses the infrared line 105, the vehicle is within the permissible height, entrance gate will be in ON position and the vehicle will pass through the entrance gate to the garage or parking lot. Further, as shown in FIG. 5B, if the vehicle crosses the infrared line 105, this gives an indication that the vehicle is above the permissible height and thus is not allowed to or should not enter the garage/parking gate 503. In such an event, as the vehicle crosses the upper infrared line, entrance gate will remain in OFF position and will block the entrance way to the garage or parking lot. Further, a message will also be displayed onto the electronic sign 107 for driver to read that the vehicle is above the permissible height.

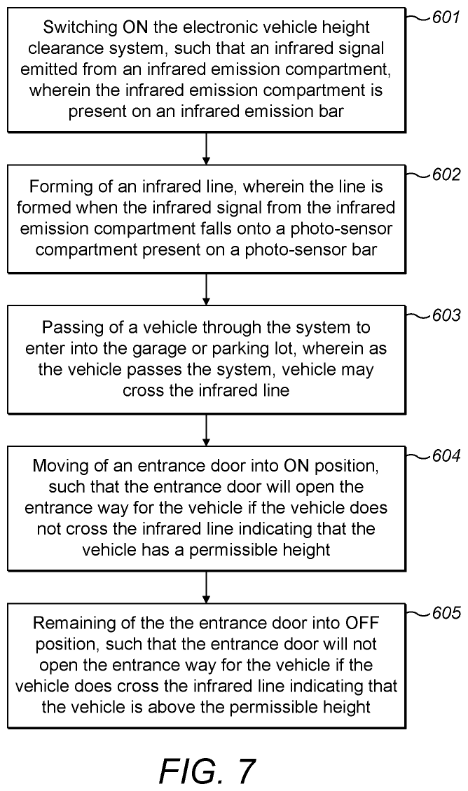

FIG. 6 shows a step-by-step functioning of the disclosed system with a vehicle of a permissible height. The functioning as disclosed comprises: switching ON the electronic vehicle height clearance system, such that an infrared signal is emitted from an infrared emission compartment, wherein the infrared emission compartment is present on an infrared emission bar 601; forming of an infrared line, wherein the line is formed when the infrared signal from the infrared emission compartment falls onto a photo-sensor compartment present on a photo-sensor bar 602; passing of a vehicle through the system to enter into the garage or parking lot, wherein as the vehicle passes the system, vehicle may cross the infrared line 603; moving of an entrance door into ON position, such that the entrance door will open the entrance way for the vehicle if the vehicle does not cross the infrared line indicating that the vehicle has a permissible height 604; remaining of the entrance door into OFF position, such that the entrance door will not open the entrance way for the vehicle if the vehicle does cross the infrared line indicating that the vehicle is above the permissible height 605.

This is total electronic system, that does not require human intervention. The system depend on photo-sensors and infrared to detect the vehicle upper height. It prevent the vehicle from the entering the garage or parking automatically by closing the garage gate and giving the driver a warning and electronic explanation. Using infrared line help to differentiate in fraction of seconds between a vehicle with acceptable and unacceptable height.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. An electronic vehicle height clearance system, comprising:
an infrared emission bar positioned on one side of an entrance gate facing a photo-sensor bar, wherein the infrared emission bar comprises of a shaped body and an infrared piece that emits an infrared signal towards the photosensor bar and if a vehicle if below the line of the infrared signal then the vehicle is allowed to pass inside an entrance gate;
the photo-sensor bar is positioned on the other side at the same height as of the infrared emission bar and is situated on the same line of axis as the infrared emission bar;
the entrance gate having an ON and Off position to permit entry to not permit for the vehicle; and
an electronic sign, wherein the system help in managing a vehicle with height above or below a permissible level for an area where the system is installed.

2. The electronic vehicle height clearance system of claim 1, further comprises an infrared emission compartment fixed onto the infrared emission bar.

3. The electronic vehicle height clearance system of claim 1, further comprises a photo-sensor compartment fixed onto the photo-sensor bar.

4. The electronic vehicle height clearance system of claim 2, wherein the infrared emission compartment comprises an infrared piece such that the infrared piece emits an infrared signal.

5. The electronic vehicle height clearance system of claim 3, wherein a photo-sensor piece present on the photo-sensor compartment.

6. The electronic vehicle height clearance system of claim 1, wherein an entrance gate is either in ON or OFF position, where ON position indicates that the entrance gate is blocking the entry of the vehicle and OFF position indicates that the gate is away for entry of the vehicle.

7. The electronic vehicle height clearance system of claim 1, wherein the photo-sensor bar is at a distance of 0.5 meter away from an entrance gate.

8. The electronic vehicle height clearance system of claim 1, wherein the photo-sensor bar is at a distance of 2.5 meters from the infrared emission bar.

9. The electronic vehicle height clearance system of claim 2, wherein the infrared emission compartment is fixed at a position indicating highest permissible vehicle height for the area where the system is installed.

10. The electronic vehicle height clearance system of claim 1, wherein an electronic sign is present on an entrance gate, such that the electronic sign display a warning message for driver of the vehicle.

11. A functioning of an electronic vehicle height clearance system, comprising:
switching ON the system, such that an infrared signal is emitted from an infrared emission compartment;
forming of an infrared line, wherein the infrared line is formed when the infrared signal from the infrared emission compartment falls onto a photo-sensor compartment present on a photo-sensor bar;
moving of an entrance gate into an entrance way to a garage or a parking lot, such that the entrance gate blocks the entrance way for a vehicle;
passing of the vehicle through the electronic vehicle height clearance system to enter into the garage or parking lot only when the infrared line if formed for a specific vehicle; and
moving of the vehicle into the garage or parking lot through an entrance gate, such that if the vehicle is within permissible height it will not cross the infrared line and will lead to opening of the entrance gate.

12. The functioning as in claim 11, wherein the functioning further comprises:
blocking of the entrance way, wherein the entrance way will be blocked by the entrance gate being in close position; and
displaying a message onto an electronic sign, wherein the electronic sign indicates a message to driver that the vehicle is above the permissible height.

13. The functioning as in claim 11, wherein the photo-sensor bar may be present at a distance of 2.5 meters from the infrared emission compartment, such that the photo-sensor bar and the infrared emission bar each are present on opposite side of the garage or the parking lot entrance gate.

14. The functioning as in claim 11, wherein the photo-sensor bar is present at a distance of 0.5 meter away from the entrance gate.

15. The functioning as in claim 11, wherein a warning message is displayed on the electronic sign as the vehicle crosses the infrared line.

16. The functioning as in claim 11, wherein the infrared emission compartment is positioned at a position indicating the highest permissible vehicle height for the garage or a parking lot.

17. The functioning as in claim 11, wherein the system helps in differentiating between a vehicle with acceptable and unacceptable height.

18. The functioning as in claim 11, wherein the entrance gate is either in ON or OFF position, where ON position indicates that the entrance gate is blocking the entrance of the vehicle and OFF position indicates that the gate is away for entrance of the vehicle.
